(19) United States
(12) Patent Application Publication
(10) Pub. No.: US 2007/0145777 A1
(43) Pub. Date: Jun. 28, 2007

(54) SUPPORT STRUCTURE FOR A CARGO DECK OF A TRANSPORT VEHICLE

(76) Inventors: Amanda Beatty, Stony Plain (CA); Dave Beatty, Terrace (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/608,654

(22) Filed: Dec. 8, 2006

(30) Foreign Application Priority Data
Dec. 22, 2005 (CA) 2532263

(51) Int. Cl. B62D 25/20

(52) U.S. Cl. 296/184.1

(57) ABSTRACT

A support structure for a cargo deck of a transport vehicle including a rigid support frame with a suspension supported by the support frame. The deck is positioned on the suspension, such that the deck floats vertically relative to the support frame on the suspension. A guide assembly is provides to guide vertical movement of the deck relative to the support frame, while providing lateral stability to the deck relative to the support frame.

### FIELD OF THE INVENTION

The present invention relates to a support structure for a cargo deck of a transport vehicle and, in particular, a transport vehicle having a flat cargo deck used to haul large or sensitive vehicles or other cargo that is presently sustaining stress fractures or vibration damage during transport.

### BACKGROUND OF THE INVENTION

The present invention was developed for the purpose of protecting large or sensitive vehicles from sustaining damage when being transported on a flat cargo deck. U.S. Pat. No. 4,494,766 (McHugh et al 1985) entitled “Trailer for carrying large vehicles” discloses an alternative approach.

### SUMMARY OF THE INVENTION

According to the present invention there is provided a support structure for a cargo deck of a transport vehicle including a rigid support frame with a suspension supported by the support frame. The deck is positioned on the suspension, such that the deck floats vertically relative to the support frame on the suspension. A guide assembly is provided to guide vertical movement of the deck relative to the support frame, while providing lateral stability to the deck relative to the support frame.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view of the support structure for a cargo deck of a transport vehicle constructed in accordance with the teachings of the present invention.

FIG. 2 is a top plan view of the support structure for a cargo deck of a transport vehicle illustrated in FIG. 1, with the deck removed to show the support structure and the female guides.

FIG. 3 is a top plan view of the air bag mounting illustrated in FIG. 2.

FIG. 4 is a front elevation view of the air bag mounting illustrated in FIG. 1.

FIG. 5 is a top plan view of the female guide illustrated in FIG. 2.

FIG. 6 is a front elevation view of the support structure for a cargo deck of a transport vehicle illustrated in FIG. 1.

### DETAILED DESCRIPTION OF THE PREFERRED EMBODIMENT

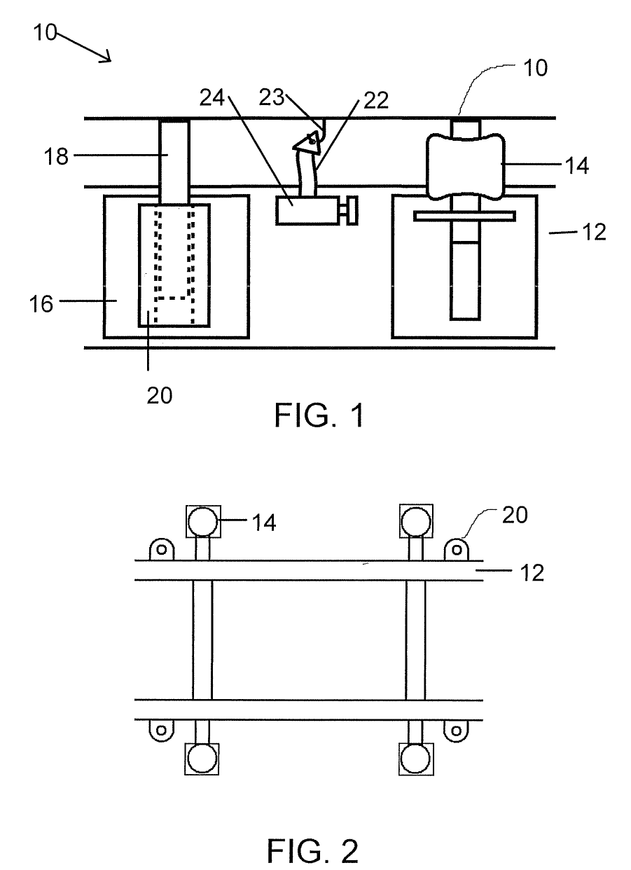

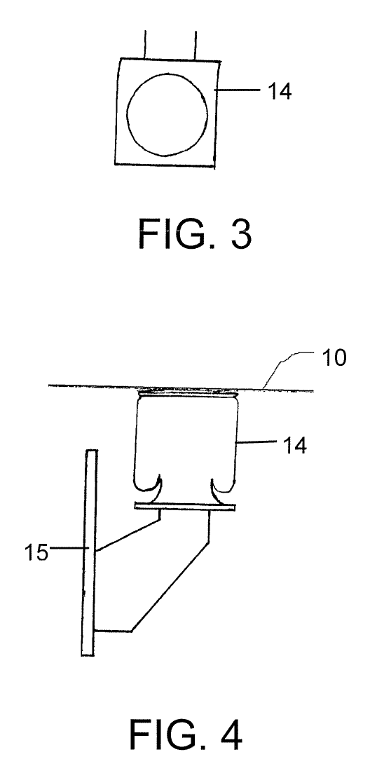

The preferred embodiment, a support structure for a cargo deck of a transport vehicle generally identified by reference numeral 10, will now be described with reference to FIG. 1 through FIG. 6.

### Structure:

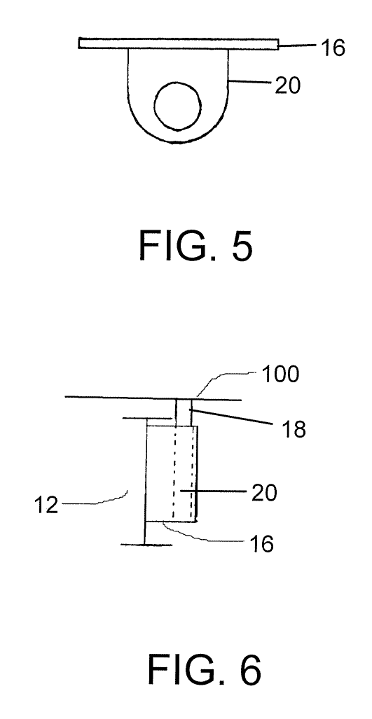

Referring to FIG. 1, there is shown a cargo deck 100 of a transport vehicle (not shown). Referring to FIG. 2, support structure 10 includes a rigid support frame 12 with an air bag suspension 14 mounted on support frame 12. Referring to FIG. 1, Cargo deck 100 is positioned on air bag suspension 14, such that deck 100 floats vertically relative to support frame 12 on air bag suspension 14. Referring to FIG. 4, air bag suspension 14 is attached to support frame 12 by a mounting plate 15. Referring to FIG. 1, a guide assembly 16 is provided which is adapted to guide vertical movement of deck 100 relative to support frame 12, while providing lateral stability to deck 100 relative to support frame 12. Referring to FIG. 6, in the preferred embodiment, guide assembly 16 includes male guides 18 which depend from deck 100 and which are adapted to mate with female guides 20 on support frame 12, as seen in FIG. 5. It will be appreciated that other forms of guides could be used.

Referring to FIG. 1, it is preferred that some means be provided to clamp deck 100 down onto support frame 12. In the preferred embodiment, the means to clamp deck 100 down onto support frame 12 consists of tie down straps 22 that extend vertically and attach to hooks 23 or other attachment means securely attached to deck 100. It will appreciated that straps 22 could also be extended completely across deck 100. Extending straps across deck 100 is not preferred, due to the fact that the strap can become damaged by contact with cargo. Some means must be provided for applying tension to tie down straps 22. In the preferred embodiment the means for applying tension to tie down straps 22 are winches 24.

Operation:

The use and operation of support structure for a cargo deck of a transport vehicle generally identified by reference numeral 10, will now be described with reference to FIG. 1 through 6. Referring to FIG. 1, to use support structure for a cargo deck of a transport 10, as described above, deck 100 is placed upon support frame 12 and floats on air bag suspension 14. Referring to FIG. 4, air bag suspension 14 cushions deck 100 from the jarring impacts and the twisting that support frame 12 is subjected to. Guide assembly 16, as seen in FIG. 6, guides the vertical movement of deck 100 and provides lateral stability to deck 100 relative to support frame 12. When deck 100 does not have a load, or the load being transported does not require the deck 100 to float, deck 100 can be secured to support frame 12 by tie down straps 22 and winches 24, so that it no longer floats.

Variations:

In the preferred embodiment, the male guides are shown as being secured to the deck and the female guides are shown as being secured to the support frame. It will be apparent to one skilled in the art that this could be reversed, with the female guides secured to the deck and the male guides secured to the support frame. It will also be apparent that a different guide system could be employed.

In the preferred embodiment, the suspension used is an air bag suspension. It will be apparent to one skilled in the art that there are alternatives to air bag suspensions that could be used. For example, the suspension could use coil spring shock absorbers or hydraulic shock absorbers.

In the preferred embodiment, the cargo deck is an open deck, where the entire deck floats. It will be apparent to one skilled in the art that the cargo deck could be enclosed to protect cargo from the elements, and portions of the deck could be allowed to float independently from the rest of the deck, where other portions of the deck are also suspended, or are rigidly connected to the rigid support frame

In this patent document, the word “comprising” is used in its non-limiting sense to mean that items following the words are included, but items not specifically mentioned are not excluded. A reference to an element by the infinite article “a” does not exclude the possibility that more than one of the elements is present, unless the context clearly requires that there be one and only one of the elements.

It will be apparent to one skilled in the art that modifications may be made to the illustrated embodiment without departing from the spirit and scope of the invention as hereinafter defined by claims.

What is claimed is:

1. A support structure for a cargo deck of a transport vehicle, comprising:
a rigid support frame;
a suspension supported by the support frame;
at least a portion of the deck positioned on the suspension, such that all or the portion of the deck floats vertically relative to the support frame on the suspension; and
a guide assembly adapted to guide vertical movement of the deck relative to the support frame, while providing lateral stability to the deck relative to the support frame.

2. The support structure as defined in claim 1, wherein the suspension is an air bag suspension.

3. The support structure as defined in claim 1, wherein the guide assembly includes male guides on one of the deck or the support frame which mate with female guides on an other of the deck or the support frame.

4. The transport vehicle as defined in claim 1, wherein means are provided to clamp the deck down onto the support frame.

5. The support structure as defined in claim 4, wherein the means to clamp the deck down onto the support frame are tie down straps that attach to the deck and means for applying tension to the tie down straps.

6. The support structure as defined in claim 5, wherein the means for applying tension to the tie down straps are winches.

7. A support structure for a cargo deck of a transport vehicle, comprising:
a rigid support frame;
an air bag suspension mounted on the support frame;
the deck positioned on the air bag suspension, such that the deck floats vertically relative to the support frame on the air bag suspension; and
a guide assembly adapted to guide vertical movement of the deck relative to the support frame, while providing lateral stability to the deck relative to the support frame, the guide assembly including male guides on the deck which mate with female guides on the support frame.

8. The support structure as defined in claim 7, wherein means are provided to clamp the deck down onto the support frame.

9. The support structure as defined in claim 8, wherein the means to clamp the deck down onto the support frame are tie down straps that attach to the deck and means for applying tension to the tie down straps.

10. The support structure as defined in claim 9, wherein the means for applying tension to the tie down straps are winches.
